(19) United States
(12) Patent Application Publication
(10) Pub. No.: US 2019/0230339 A1
(43) Pub. Date: Jul. 25, 2019

(54) IMAGE SENSOR CAPABLE OF ENHANCING IMAGE RECOGNITION AND APPLICATION OF THE SAME

(71) Applicants: Kuan-Yu Lu, Taipei City (TW); Wei-Hsin Huang, Taipei City (TW); Wei-Hung Chang, Taipei City (TW); Chun-Shing Chu, Taipei City (TW)

(72) Inventors: Kuan-Yu Lu, Taipei City (TW); Wei-Hsin Huang, Taipei City (TW); Wei-Hung Chang, Taipei City (TW); Chun-Shing Chu, Taipei City (TW)

(21) Appl. No.: 15/876,372

(22) Filed: Jan. 22, 2018

(51) Int. Cl. H04N 13/214; H04N 5/3745; H04N 5/225; H04N 9/07; H04N 5/33; H04N 5/232; H04N 5/345

(52) U.S. Cl. CPC H04N 13/214; H04N 5/37455; H04N 5/2256; H04N 5/37457; H04N 5/332; H04N 5/23229; H04N 5/345; H04N 9/07

(57) ABSTRACT

An image sensor capable of enhancing image recognition and application of the same, wherein the image sensor includes: a photosensitive pixel array, connected to a packaging circuit, that is used to drive the photosensitive pixel array to capture outside light, and convert outside light into combined image signal, the photosensitive pixel array captures full color RGB visible light and infrared (IR) invisible light, to perform photoelectric conversion; the packaging circuit is connected electrically to the photosensitive pixel array; and an image enhanced process unit, embedded in the packaging circuit, to control and regulate the image captured by the photosensitive pixel array. The captured image includes: a full color RGB visible light wide range image signal, and at least two Infrared (IR) invisible lights narrow range image signals. The two kinds of image signals are superimposed and combined into clear output image having stereoscopic sense of layers.

### BACKGROUND OF THE INVENTION

### Field of the Invention

The present invention relates to an image sensor, and in particular to an image sensor capable of enhancing image recognition and the application of the same, that is capable of capturing fully the details of images at both daytime and nighttime, so that the combined image produced may give a stereoscopic sense of layers.

### The Prior Arts

In general, for the conventional image sensor presently available on the market, the equipment shown in FIG. 9A must be used to effectively capture the images at both daytime and nighttime. As shown in FIG. 9A, a single RGB full color lens A is utilized in cooperation with an ordinary MONO black and white lens B, or a starlight night vision lens (not shown), to realize its function. Further, as shown in FIG. 9B, for the conventional image sensor, a plurality of supplementary lamps C are provided around its perimeter to serve as an auxiliary light source when lights are insufficient, to capture the images having waveform of relative spectrum sensitivity (%) vs wavelength as shown in FIG. 10. As such, in daytime when sun light is available, images of color saturation can be obtained through capturing red light (R), green light (G), and blue light (B) of the visible light source RGB. While in nighttime, when visible lights are insufficient, the infrared lights are captured, to achieve increased vision range. In fact, the night vision range at nighttime is of a wavelength less than 850 nm, so its application is rather limited. Due to its short nighttime vision range, inferior performance, and high cost, presently, the conventional image sensor is used mainly in the consumer market, but rarely in the Industries.

In a more advanced design, a single piece image sensor capable of combining full color and Infrared (IR) lights together is developed, yet its image processing function is not sufficient, so the waveform of the image signal obtained is still similar to that as shown in FIG. 10, yet its performance in application is not satisfying.

More importantly, for the images obtained through the two types of conventional image sensors mentioned above, the images taken at daytime and nighttime are still not clear enough. In particular, the major disadvantages are that, since the effective night vision range is limited, the image is not clear enough to provide sufficient recognition. The image thus produced is of a planar type and lack of sense of stereoscope, and when it is irradiated by light of high intensity, it is liable to have the problem of instantaneous over-exposure and can not be recognized.

Therefore, presently, the design and performance of the image sensor is not quite satisfactory, and it leaves much room for improvement.

### SUMMARY OF THE INVENTION

In view of the problems and drawbacks of the prior art, the present invention provides an image sensor capable of enhancing image recognition and the application of the same, to effectively overcome the shortcomings of the prior art.

A major objective of the present invention is to provide an image sensor capable of enhancing image recognition, that includes: a photosensitive pixel array, a packaging circuit, and an image enhanced process unit. The photosensitive pixel array is connected electrically to a packaging circuit (chip), that is used to drive the photosensitive pixel array to capture the outside light, and convert the light into combined image signals. Wherein, the photosensitive pixel array is able to capture full color RGB visible light and infrared (IR) invisible light, to perform photoelectric conversion.

The image enhanced process unit is embedded in the packaging circuit, to control and regulate the image captured by the photosensitive pixel array. The captured image includes: a full color RGB visible light wide range image signal, the wavelength range of full color RGB visible light wide range image signal is between 300 nm and 350 nm±20 nm; and at least two Infrared (IR) invisible light narrow range image signal, the wavelength range of Infrared (IR) invisible light narrow range image signal is between 35 nm and 50 nm±20 nm.

In implementation, the wide range image signal and the at least two narrow range image signals are superimposed and combined into a clear output image having stereoscopic sense of layers.

Preferably, the wavelength range of the wide range image signal is between 400 nm and 700 nm, while the wavelength range of the narrow range image signal is between 850 nm and 940 nm.

As such, the image sensor capable of enhancing image recognition and the application of the same of the present invention can be utilized in the various products of security monitoring, industry monitoring, face recognition, Webcam, drone, robot, and car backup image fetching.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of an image sensor capable of enhancing image recognition according to the present invention;

FIG. 2 is a block diagram for a packaging circuit according to the present invention;

FIG. 3 is a waveform diagram of the wavelength range for an image received by an image sensor capable of enhancing image recognition according to the present invention;

FIG. 4 is a flowchart of a method of the steps for implementing an image sensor capable of enhancing image recognition according to the present invention;

FIG. 5 is another waveform diagram of the wavelength range for an image received by an image sensor capable of enhancing image recognition according to the present invention;

FIG. 6 is a schematic diagram of an image sensor module containing an image sensor capable of enhancing image recognition according to the present invention;

FIG. 7 is an exploded view of a lens according to the present invention;

FIGS. 8A, 8B, and 8C are schematic diagrams respectively showing how to implement an image sensor module of the present invention;

FIGS. 9A and 9B are enlarged views respectively of the lenses and the supplementary lamps for the image sensor according to the Prior Art; and

FIG. 10 is a waveform diagram for the image signals received by the image sensor according to the Prior Art.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

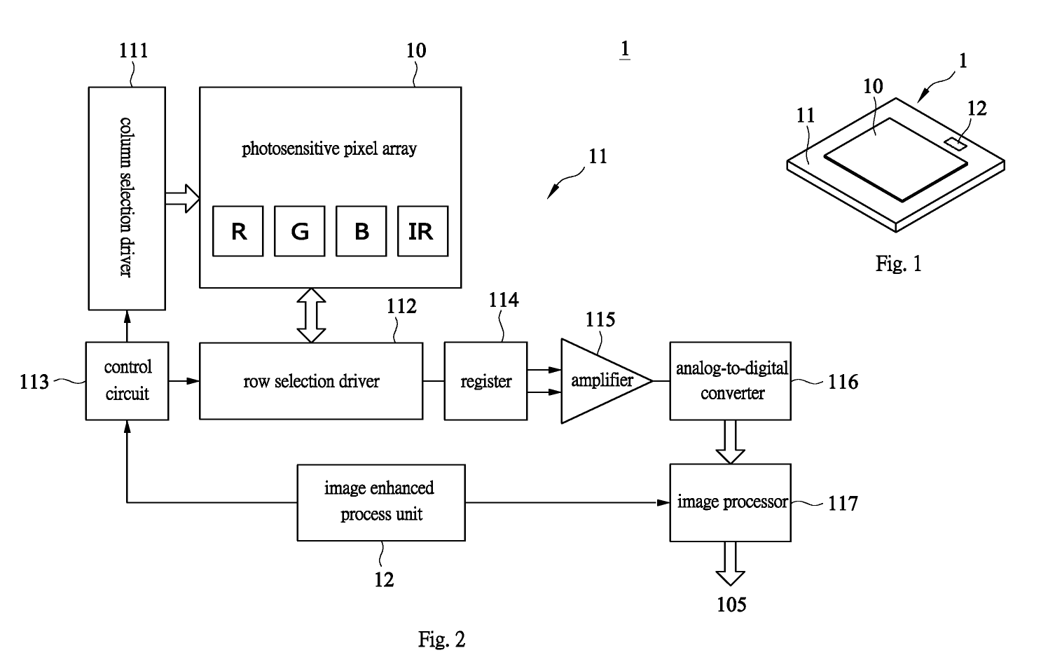

Refer to FIGS. 1-4 respectively for a schematic diagram of an image sensor capable of enhancing image recognition according to the present invention; a block diagram for a packaging circuit (chip) according to the present invention; a waveform diagram of the wavelength range for an image received by an image sensor capable of enhancing image recognition according to the present invention; and a flowchart of a method of the steps for implementing an image sensor capable of enhancing image recognition according to the present invention.

As shown in FIGS. 1 to 4, the present invention provides an image sensor capable of enhancing image recognition 1, that includes: a photosensitive pixel array 10, a packaging circuit (chip)11, and an image enhanced process unit 12. Wherein, the photosensitive pixel array 10 is connected electrically to the packaging circuit (chip) 11, that is used to drive the photosensitive pixel array 10 to capture the outside light, and convert the light into a combined image signal. The photosensitive pixel array 10 is able to capture full color RGB visible light and infrared (IR) invisible light, to perform photoelectric conversion.

The image enhanced process unit 12 is embedded in the packaging circuit 11, to control and regulate the image captured by the photosensitive pixel array, the captured image includes: a full color RGB visible light wide range image signal 101, the wavelength range of full color RGB visible light wide range image signal 101 is between 300 nm and 350 nm±20 nm; and at least two Infrared (IR) invisible light narrow range image signal 102, and 103, the wavelength ranges of Infrared (IR) invisible light narrow range image signals 102, and 103 are between 35 nm and 50 nm±20 nm respectively.

Preferably, the wavelength range of the wide range image signal 101 is between 400 nm and 700 nm, while the wavelength ranges of the narrow range image signals 102 and 103 are between 850 nm and 940 nm respectively. The wavelength range for the narrow range image signals 102 is at 850 nm, and wavelength range for the narrow range image signals 103 is at 940 nm.

In implementation, the wide range image signal 101 and the at least two narrow range image signals 102, 103 are superimposed and combined into an output image signal 105, that can be used to produce a clear image having stereoscopic sense of layers.

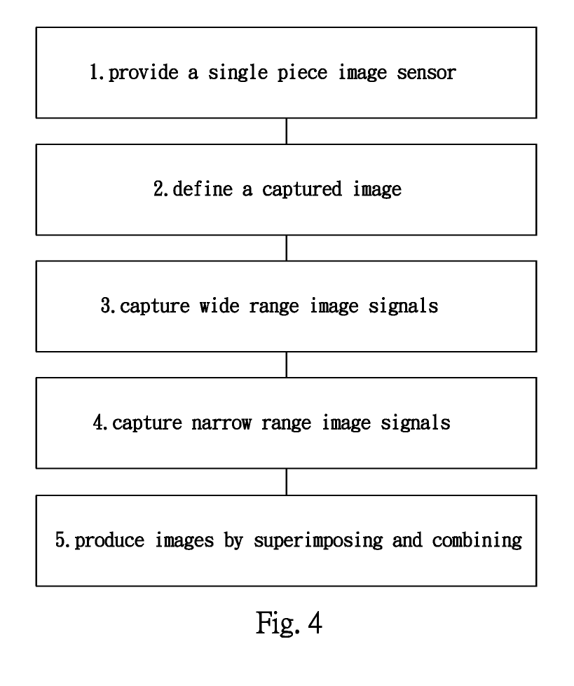

In an embodiment of the present invention, as shown in FIG. 4, the method of the steps of implementing an image sensor capable of enhancing image recognition includes the following steps: 1. provide a single piece image sensor 1, having an embedded image enhanced process unit 12 disposed therein, to capture image at daytime and nighttime through photoelectric conversion; 2. define the captured image, such that the captured image contains: a visible light wide range image signal 101, and at least two invisible light narrow range image signals 102 and 103; 3. fetch the wide range image signal 101, such that its wavelength range is between 400 nm and 700 nm; 4. fetch the narrow range image signals 102 and 103, such that their wavelength ranges are between 850 nm and 940 nm, and the wavelength ranges for the narrow range image signals 102 and 103 are between 35 nm and 50 nm±20 nm respectively; and 5. superimpose and combine the visible light wide range image signal 101 with the two invisible light narrow range image signals 102 and 103, to form an output image signal 105, that is used to produce a clear image having stereoscopic sense of layers.

In an embodiment of the present invention, as shown in FIG. 2, the packaging circuit 11 includes: a column selection driver 111, a row selection driver 112, a control circuit 113, a register 114, an amplifier 115, an analog-to-digital converter (ADC) 116, and an image processor 117. The column selection driver 111 is connected electrically to one side of the photosensitive pixel array 10, and the row selection driver 112 is connected electrically to an adjacent side of the photosensitive pixel array 10. The control circuit 113 is connected electrically to the column selection driver 111 and the row selection driver 112, to select the row address and column address for switching between conduction and non-conduction. The register 114 is connected electrically to the row selection driver 112, to receive and store the photoelectric signals. The amplifier 115 is connected electrically to the register 114, to amplify the photoelectric signals received therefrom. The analog-to-digital converter (ADC) 116 is connected electrically to the amplifier 115, to convert the amplified photoelectric analog signals into digital signals. And the image processor 117 is connected electrically to the analog-to-digital converter (ADC) 116, to combine the digital signals into an output image signal 105. In addition, the image enhanced process unit 12 is connected electrically to control the control circuit 113 and the image processor 117.

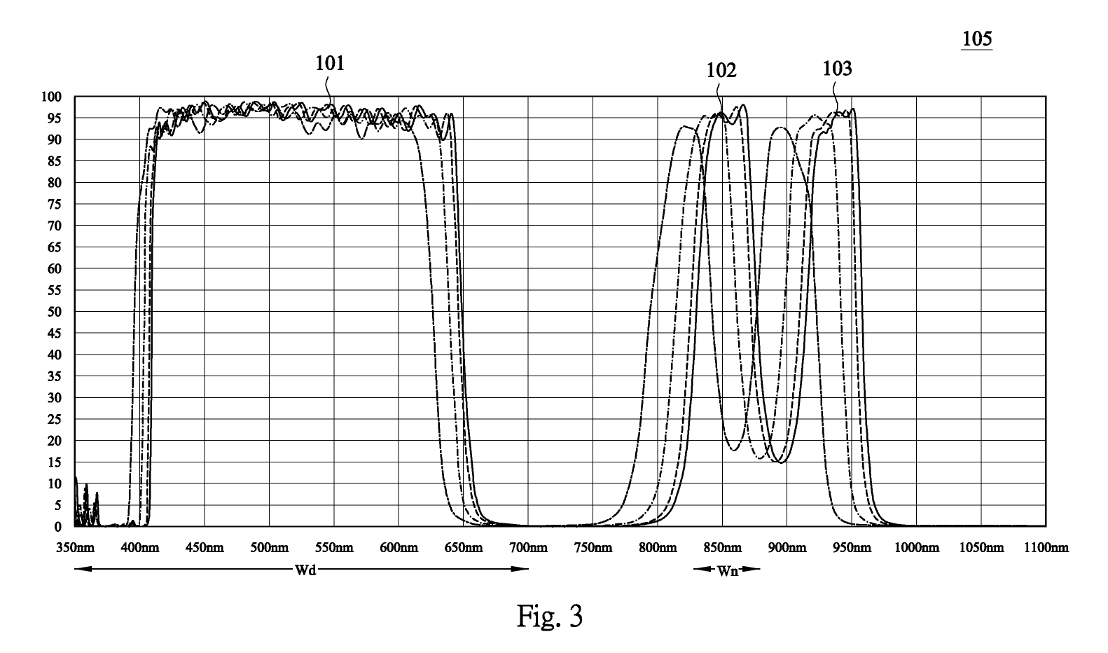

In an embodiment of the present invention, as shown in FIGS. 2 and 3, the image enhanced process unit 12 is used to control the control circuit 113 and the image processor 117. Therefore, the image sensor 1 having embedded image enhanced process unit 12 is capable of capturing effectively a full color RGB visible light wide range image signal 101, and at least two Infrared (IR) invisible light narrow range image signals 102 and 103. As such, the optical image technology and the optical communication technology are used in combination, to fetch, superimpose, and combine the full color RGB visible light wide range image signal 101, and at least two Infrared (IR) invisible light narrow range image signals 102 and 103, so that the output image signal 105 is clear and having stereoscopic sense of layers. In particular, in the combined signals, the two Infrared (IR) invisible light narrow range image signals 102 and 103 having different wavelengths between 850 nm and 940 nm respectively are superimposed, so that the effective range of night vision can be lengthened to far surpass the Prior Art, to raise the clearness and stereoscopic sense of layers of the output image. In this approach, a single piece image sensor 1 is able to produce clear images through capturing lights of daytime and nighttime.

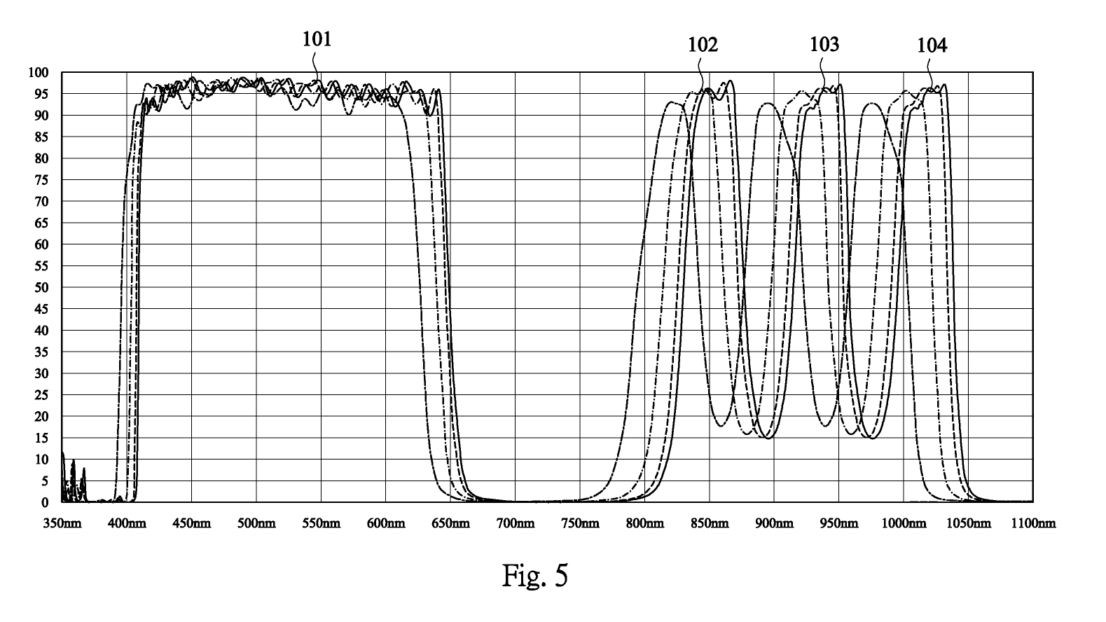

In an embodiment of the present invention, as shown in FIGS. 1 and 3 the image enhanced process unit 12 can be realized through software or firmware, to facilitate adding the amount of narrow range image signals, or adjusting the light transmittance of the image to between 30% and 95%. By way of example, as shown in FIG. 5 in capturing lights to form images, another narrow range image signal 104 of wavelength 1050 nm can be added. As such, through superimposing and combining the three Infrared (IR) invisible light narrow range image signals 102, 103, and 104 of wavelengths 850 nm, 940 nm, and 1050 nm respectively, the range of night vision can be increased, while the clearness and sense of stereoscope can be raised significantly. The above example is for illustrations only, the amount of narrow range image signals utilized is not limited to this, and in fact, it can be designed and graded into various specifications depending on actual requirements. In this approach, an image sensor capable of enhancing image recognition suitable for used in daytime and nighttime can be custom-made depending on the shooting angle, range, and effects required, to provide image formed by image signals of various wavelengths. Therefore, this type of image sensor can be utilized in the various products of security monitoring, industry monitoring, face recognition, Webcam, drone, robot, and car backup image fetching.

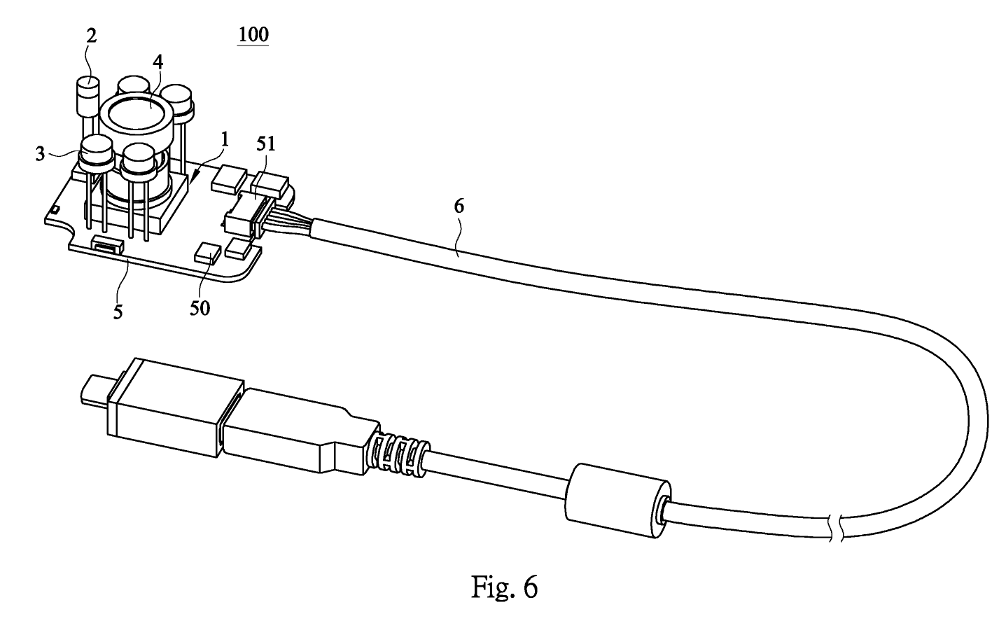

In an embodiment of the present invention, as shown in FIG. 6, the image sensor 1 of the present invention can be used to form an image sensor module 100, and that includes: an electric circuit board 5, an image sensor 1, a photosensitive resistor 2, at least 4 LED lamps 3, a lens 4, an image processing circuit 50, and a connector 51. The image sensor 1 is disposed on the electric circuit board 5. The photosensitive resistor 2 is disposed on a side of the image sensor 1. The at least 4 LED lamps 3 are disposed respectively on the four corners of the image sensor 1. The lens 4 is disposed on the image sensor 1. The image processing circuit 50 is disposed on the electric circuit board 5. The connector 51 is disposed on a side of the electric circuit board 5, to provide output image signals to an outside cable 6. Also, as shown in FIGS. 1,3, the image sensor 1 includes: a photosensitive pixel array 10, a packaging circuit 11, and an image enhanced process unit 12. The packaging circuit 11 is connected electrically to the photosensitive pixel array 10, to drive the photosensitive pixel array 10 to fetch outside lights, and to convert the outside lights into the combined image signals. The image enhanced process unit 12 is embedded in the packaging circuit 11, to control and capture a full color RGB visible light wide range image signal 101, and at least two Infrared (IR) invisible light narrow range image signals 102 and 103, but the present invention is not limited to this. Further, the image enhanced process unit 12 combines and processes the full color RGB visible light wide range image signal 101, and at least two Infrared (IR) invisible light narrow range image signals 102 and 103, into an output image signal 105, that is used to produce a clear image having the stereoscopic sense of layers. In this way, the image sensor module 100 containing the image sensor 1 is able to receive light signal of wavelength 380 nm to 940 nm. As such, in cooperation with a software, the single piece image sensor 1 can capture images at both daytime and nighttime. Of course, in cooperation with an auxiliary light source giving lights of other wavelengths (810 nm and 880 nm), the image superimposing effects could be better.

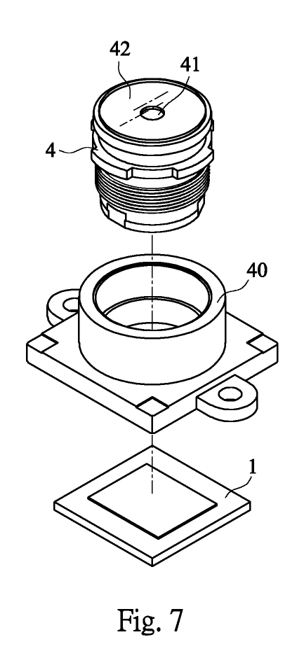

In an embodiment of the present invention, as shown in FIG. 7, a lens 4 is disposed on the image sensor 1, and it includes: a bottom seat 40, a mirror 41, and an Infrared (IR) light filter 42. The bottom seat 40 is located at the bottom of the lens 4, and is disposed on image sensor 1, and that is located on the electric circuit board 5 (as shown in FIG. 6). The Infrared (IR) light filter 42 is disposed on the mirror 41. This special design is used to enhance the capability of the image sensor module 100 to capture the IR invisible light, to raise color saturation and stereoscopic sense of the images produced. The design and structure of the present invention is quite different from the Prior Art in that, in the Prior Art, the filter is placed at the bottom of the lens, or no filter is provided at all; while in the present invention, the Infrared (IR) light filter 42 is placed on the upper layer of the mirror 41.

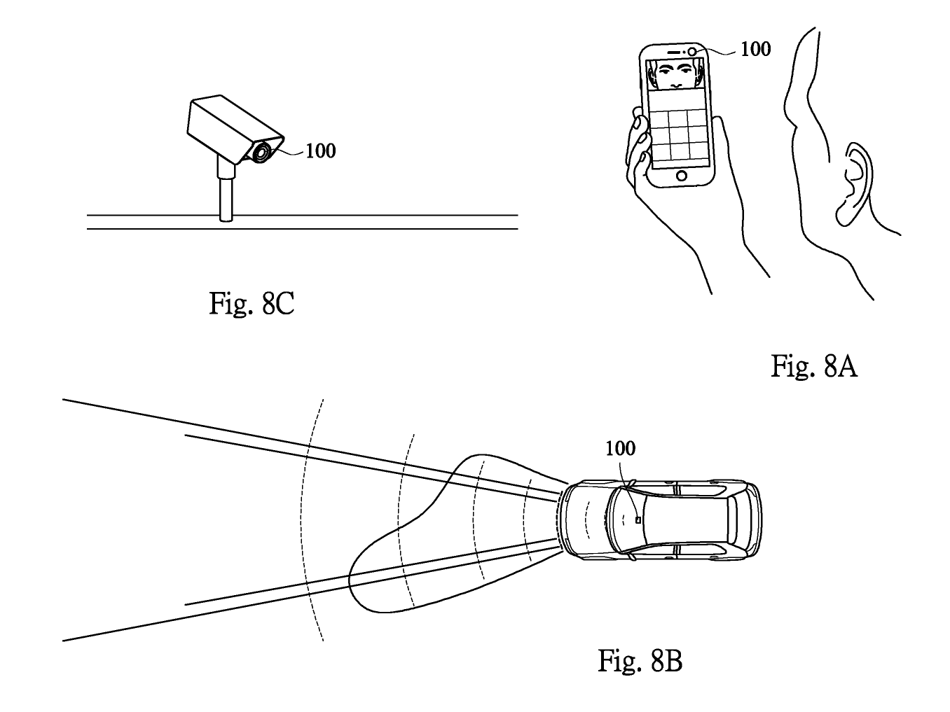

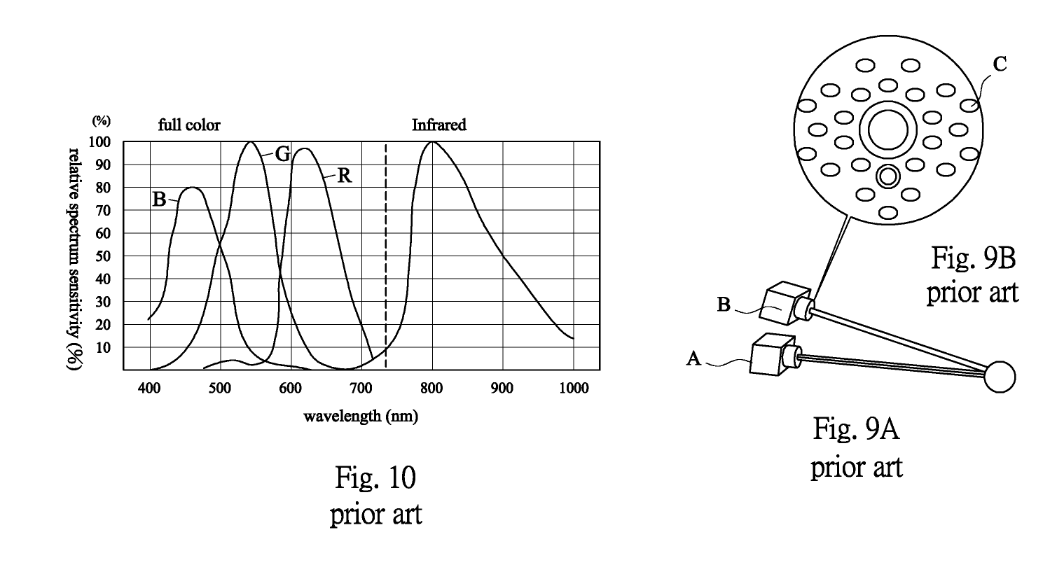

Therefore, the image sensor 1 of the present invention can be used to form an image sensor module 100 capable of enhancing image recognition, and that is used extensively in the various products of monitoring system, transportation means, face recognition, Webcam, drone, robot, and car backup image fetching. In the descriptions above, the monitoring system may include but is not limited to an indoor monitor or an outdoor monitor used for security monitoring and industrial monitoring, while the transportation means may include but not limited to a motorcycle, an automobile, a ship, and an air plane. By way of example, as shown in FIG. 8A, the image sensor module 100 can be placed in a handheld device used for face recognition. Or, as shown in FIG. 8B, the image sensor module 100 can be placed in an automobile used for enhancing night vision. Or, as shown in FIG. 8C, the image sensor module 100 can be placed in an outdoor monitor used for security monitoring. The descriptions above are for easy explanations and illustrations only, but the present invention is not limited to this. For example, the image sensor module 100 can be placed in an automobile used for car backup auxiliary image fetching, or in the electronic device in Internet of Things (not shown).

In the present invention, a wide range image signal 101, and at least two narrow range image signals 102 and 103 are superimposed and combined to form image having excellent stereoscopic sense and clear recognition. The image thus produced can be used to calculate accurately distance between an object-to-be-tested and its surroundings, gesture actions, and obstacle avoidance, and that is quite important to the emerging 3D Applications. In fact, the technology mentioned above could provide 3D depth image distance measuring function for VR/AR, drone, people/things counting. Further, that technology is able to provide accurate depth measuring capability for an object-to-be-tested and its surroundings, and is suitable for use in Artificial Intelligence and Computer Vision.

Summing up the above, the advantages of the image sensor capable of enhancing image recognition can be summarized as follows:

1. It is capable of receiving the full color range light of 380 nm to 940 nm, thus it is suitable to use in various environments.

2. It is capable of producing images of high quality to achieve good image effect. The images taken could have resolution of 2K/4K, and its vision range can be varied based on the lens used in cooperation.

3. It is made into a single module, thus it could achieve various camera effects simultaneously in cooperation with software.

4. It is made into a single module, and it can be operated 24 hours a day, to achieve the needs for daytime and nighttime image capturing.

5. It is made into a single module, while attaining the effects of two modules of the Prior Art, to reduce the cost of image sensors.

6. It is made into a single module, thus it can be used with the existing image sensor, to further reduce the cost of image sensor.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An image sensor capable of enhancing image recognition, comprising:
a photosensitive pixel array, connected electrically to a packaging circuit, that is used to drive the photosensitive pixel array to capture outside light, and convert the outside light into a combined image signal, the photosensitive pixel array captures full color RGB visible light and infrared (IR) invisible light, to perform photoelectric conversion;
the packaging circuit, connected electrically to the photosensitive pixel array; and
an image enhanced process unit, embedded in the packaging circuit, to control and regulate an image captured by the photosensitive pixel array, such that a captured image includes: a full color RGB visible light wide range image signal, a wavelength range of the full color RGB visible light wide range image signal is between 300 nm and 350 nm±20 nm; and at least two Infrared (IR) invisible light narrow range image signals, the wavelength range of the at least two Infrared (IR) invisible light narrow range image signals is between 35 nm and 50 nm±20 nm, the wide range image signal and the at least two narrow range image signals are superimposed and combined into a clear output image having stereoscopic sense of layers.

2. The image sensor capable of enhancing image recognition as claimed in claim 1, wherein the wavelength range of the wide range image signal is between 400 nm and 700 nm, while the wavelength range of the two narrow range image signals is between 850 nm and 940 nm.

3. The image sensor capable of enhancing image recognition as claimed in claim 2, wherein image enhanced process unit is used to control and regulate the photosensitive pixel array to capture an additional narrow range image signal at wavelength 1050 nm, with its wavelength range between 35 nm and 50 nm±20 nm.

4. The image sensor capable of enhancing image recognition as claimed in claim 1, wherein light transmittance of the wide range image signal and the narrow range image signal is between 30% and 95%.

5. The image sensor capable of enhancing image recognition as claimed in claim 1, wherein the packaging circuit includes: a column selection driver, a row selection driver, a control circuit, a register, an amplifier, an analog-to-digital converter (ADC), and an image processor, the column selection driver is connected electrically to one side of the photosensitive pixel array, and the row selection driver is connected electrically to an adjacent side of the photosensitive pixel array, the control circuit is connected electrically to the column selection driver and the row selection driver, to select the a row address and a column address for switching between conduction and non-conduction, the register is connected electrically to the row selection driver, to receive and store the photoelectric signals, the amplifier is connected electrically to the register, to amplify the photoelectric signals received therefrom, the analog-to-digital converter (ADC) is connected electrically to the amplifier, to convert the amplified photoelectric analog signals into digital signals, the image processor is connected electrically to the analog-to-digital converter (ADC), to combine the digital signals into an output image signal, and the image enhanced process unit is connected electrically to the control circuit and the image processor.

6. An image sensor module capable of enhancing image recognition, comprising: the image sensor, an electric circuit board, a photosensitive resistor, at least 4 LED lamps, a lens, an image processing circuit, and a connector, wherein the image sensor is disposed on the electric circuit board, the photosensitive resistor is disposed on a side of the image sensor, the at least 4 LED lamps are disposed respectively on four corners of the image sensor, the lens is disposed on the image sensor, the image processing circuit is disposed on the electric circuit board, the connector is disposed on a side of the electric circuit board, to provide output image signals to an outside cable, wherein, the image sensor is provided with a photosensitive pixel array, and a packaging circuit connected thereto, to drive the photosensitive pixel array to capture outside light, and convert it into a combined image signal, an image enhanced process unit is embedded in the packaging circuit, to control and capture a full color RGB visible light wide range image signal having a wavelength range between 300 nm to 350 nm±20 nm, and at least two Infrared (IR) invisible light narrow range image signals having wavelength ranges between 35 nm and 50 nm±20 nm respectively, the wide range image signal and the at least two narrow range image signals are superimposed and combined, to produce an image that is clear and having stereoscopic sense of layers both at daytime and nighttime.

7. The image sensor module capable of enhancing image recognition as claimed in claim 6, wherein the wavelength range of the wide range image signal is between 400 nm and 700 nm, while the wavelength ranges of the two narrow range image signals are between 850 nm and 940 nm respectively.

8. The image sensor module capable of enhancing image recognition as claimed in claim 6, wherein the lens is disposed on the image sensor, and it includes: a bottom seat, a mirror, and an Infrared (IR) light filter, the bottom seat is located at the bottom of the lens, and is disposed on the image sensor, and the image sensor is located on the electric circuit board, and the Infrared (IR) light filter is disposed on the mirror.

9. The image sensor module capable of enhancing image recognition as claimed in claim 7, wherein the image sensor module is disposed in a handheld device.

10. The image sensor module capable of enhancing image recognition as claimed in claim 7, wherein the image sensor module is disposed in an electronic device in the Internet.

11. The image sensor module capable of enhancing image recognition as claimed in claim 7, wherein the image sensor module is disposed in a transportation means, that includes but is not limited to one of the following: a motorcycle, an automobile, a ship, and an air plane.

12. The image sensor module capable of enhancing image recognition as claimed in claim 7, wherein the image sensor module is disposed in a monitoring system, that includes but is not limited to one of the following: an indoor monitor and an outdoor monitor.
